(19) United States
(12) Patent Application Publication
(10) Pub. No.: US 2023/0407927 A1
(43) Pub. Date: Dec. 21, 2023

(54) SYSTEMS FOR LINE DEVICE

(71) Applicant: CMC RESCUE, INC., Goleta, CA (US)

(72) Inventors: Ole Kils, Goleta, CA (US); Tyler J. Mayer, Carpinteria, CA (US); Alex Hurd, Lompoc, CA (US); Shaun Reed, Santa Barbara, CA (US)

(21) Appl. No.: 18/460,182

(22) Filed: Sep. 1, 2023

Related U.S. Application Data
(63) Continuation-in-part of application No. 17/351,962, filed on Jun. 18, 2021, now Pat. No. 11,781,610.

(51) Int. Cl. F16D 63/00; F16D 59/00

(52) U.S. Cl. CPC F16D 63/008; F16D 59/00; F16D 2127/005

(57) ABSTRACT

Methods and systems are provided for a device. In one example, the device is configured to automatically grab and slip a line. The device is further configured to allow a user to actuate a side plate and a cam independently of one another.

### CROSS REFERENCE TO RELATED APPLICATIONS

The present application is a continuation-in-part of U.S. Non-Provisional patent application Ser. No. 17/351,962, entitled “SYSTEMS FOR LINE DEVICE”, and filed on Jun. 18, 2021. The entire contents of the above-listed application are hereby incorporated by reference for all purposes.

### FIELD

The present description relates generally to a line grab device.

### BACKGROUND/SUMMARY

A line grabbing device may be a device configured to block and allow slipping of a line at a pre-determined load. The line grabbing device may assist a user in ascending or descending by grabbing a line via a cam or a knot. Examples of line grab devices may include a Prusik knot, ascender devices, work positioning devices, back up devices, and the like.

The Prusik knot, which attaches a loop of rope around a line may be the simplest configuration of a line grab device. The Prusik knot is relatively inexpensive, but may be vulnerable to incorrect installation and may be troublesome to set-up. Additionally, the Prusik knot may be inefficient when sliding it along a host line due to friction and may be difficult to reset to a desired position after being heavily loaded or following a slip event. During the slip event, the Prusik knot may degrade the host line and/or the lines may weld together and become difficult to separate. Furthermore, due to a variability of peak slip forces, it may be difficult to configure a Prusik knot for a variety of slip events.

Other examples of line grabbing device include non-levered and levered camming devices. In each of these examples, the cams may be spring driven and toothed in varying degrees of aggressiveness. For example, in the non-levered camming device, teeth thereof may be relatively sharp and include an acute toothing angle. The toothed cam devices may prevent slip between the rope and the cam in overload situations that may cause degradation to the host rope. In the levered camming device, it may include duller teeth with a larger toothing angle for handling higher loads. The duller teeth may decrease degradation to a line relative to sharper teeth while the cam demands a greater amount of force on the host line to grab it. A levering becket may be coupled to the cam to provide a sufficient force thereto such that a desired gripping may occur.

However, the inventors have identified some issues with the approaches described above. For example, levered camming devices may not slip under overload conditions and degrade the host line. Some mechanical devices may automatically release the line during an overload scenario, but these devices may not be configured to automatically re-grab the line. Thus, there is a demand for a line grabbing device configured to automatically slip and grab line without degrading the line due to over-rotation of the cam.

In another example, the issues described above may be addressed by a device for grabbing line including a cam arranged between a side plate and a chassis, wherein the cam comprises a first slot engaged with a side plate protrusion and a second slot engaged with a chassis protrusion

As one example, the side plate may be moved to a closed position, a first open position, or a second open position. The cam may be moved to a closed position or an open position. Based on an actuation of the side plate and/or the cam, operation of the device may be modified. In some examples, the configuration of the device may simplify operation for a user, such as allowing single-handed operation.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 illustrates a first view of a line grab device grabbing a line.

FIG. 2 illustrates a second view of the line grab device with an interior of a cam of the line grab device revealed.

FIG. 3A illustrates a groove of the cam.

FIG. 3B illustrates a shape of the line in the groove.

FIGS. 4A-4E illustrate various camming angles at different positions of the cam.

FIG. 5 illustrates an alternative shape of a cam of the line grab device.

FIG. 6A illustrates a first side of the cam.

FIG. 6B illustrates a second side of the cam.

FIG. 7A illustrates a side plate of the line grab device.

FIG. 7B illustrates a chassis of the line grab device.

FIGS. 8A-8D illustrate operation of the line grab device with line being loaded into a pulley zone.

FIGS. 9A and 9B illustrates operation of line being loaded into or unloaded from the cam.

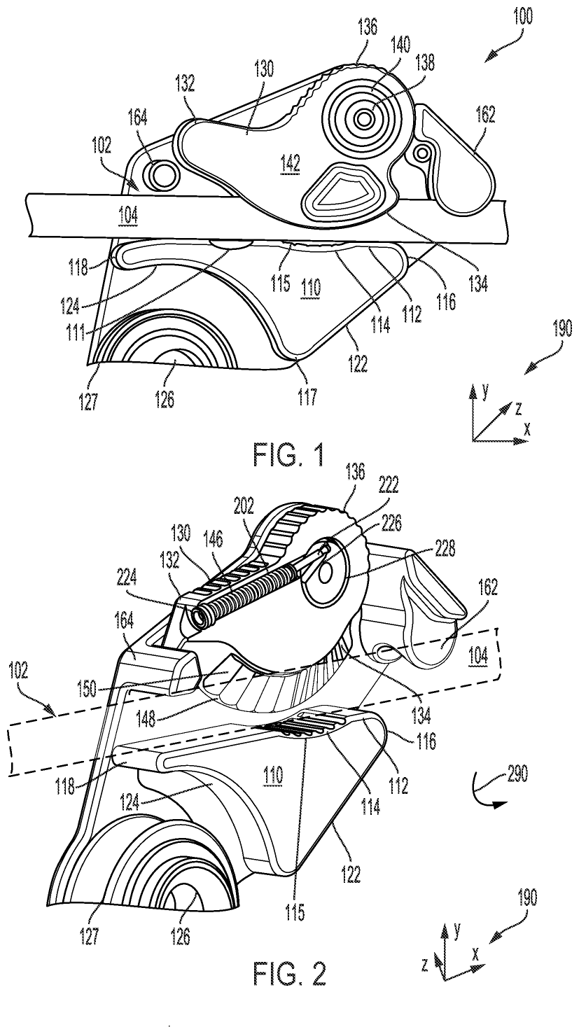

FIGS. 1 through 9B are shown approximately to scale, however, other dimensions may be used if desired.

### DETAILED DESCRIPTION

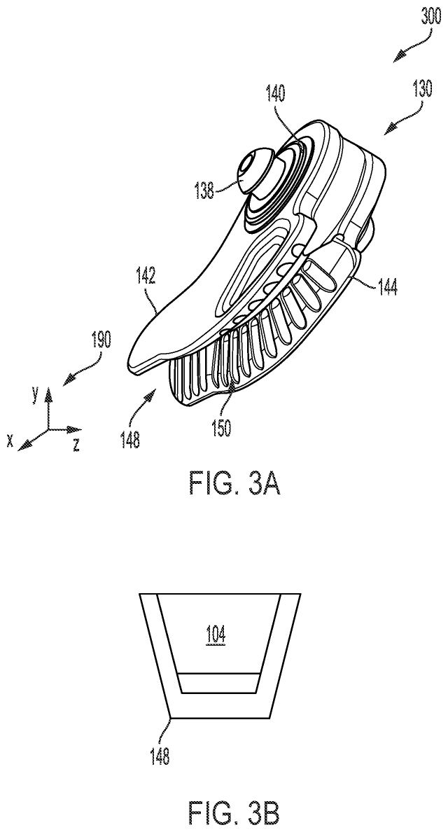

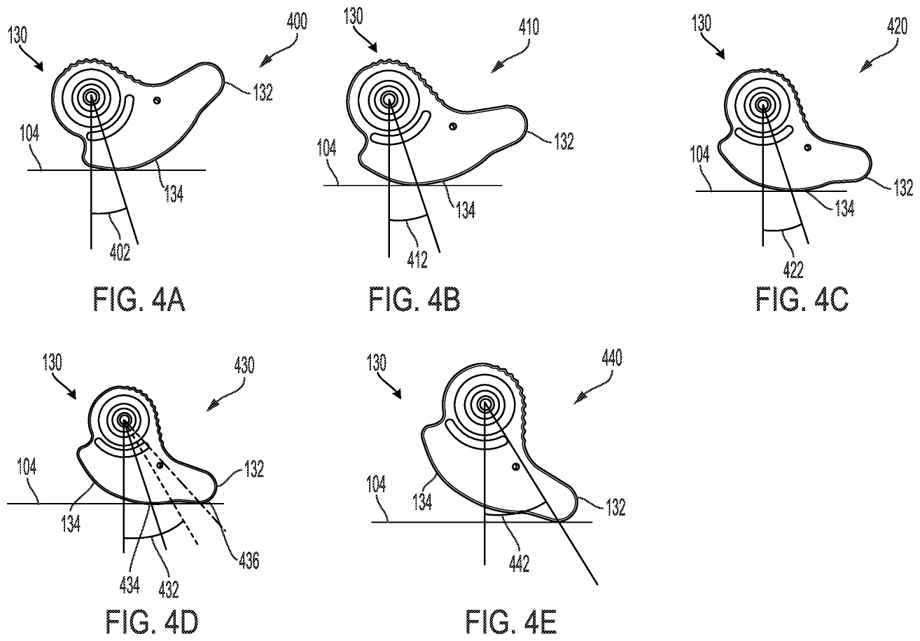

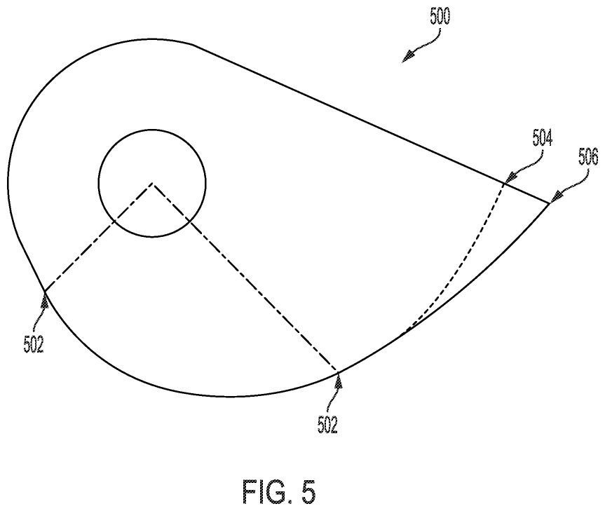

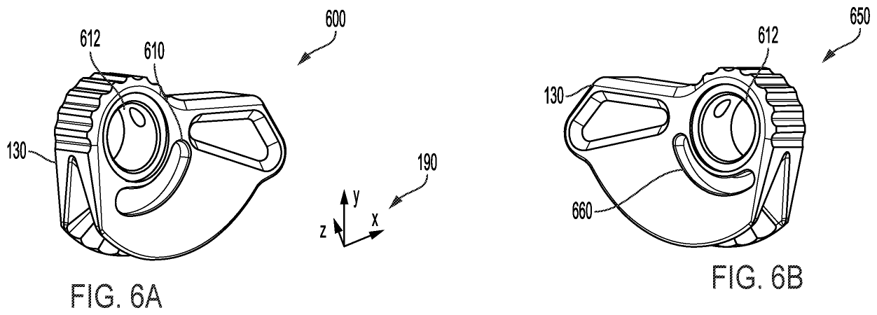

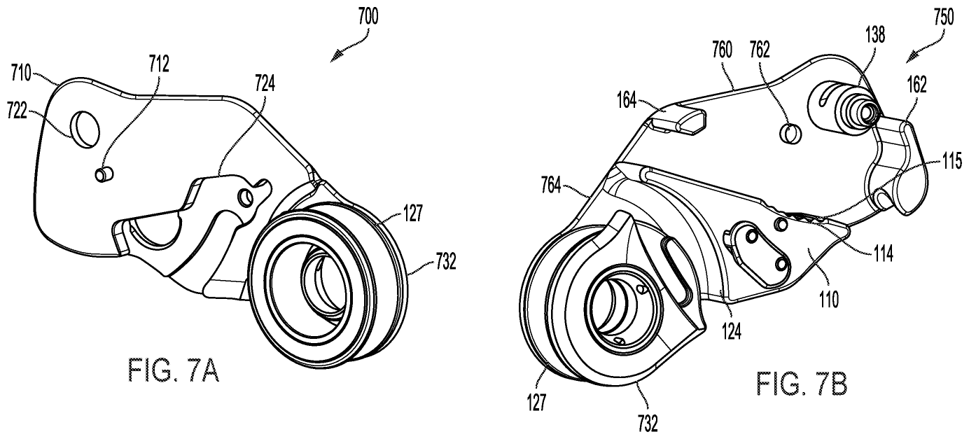

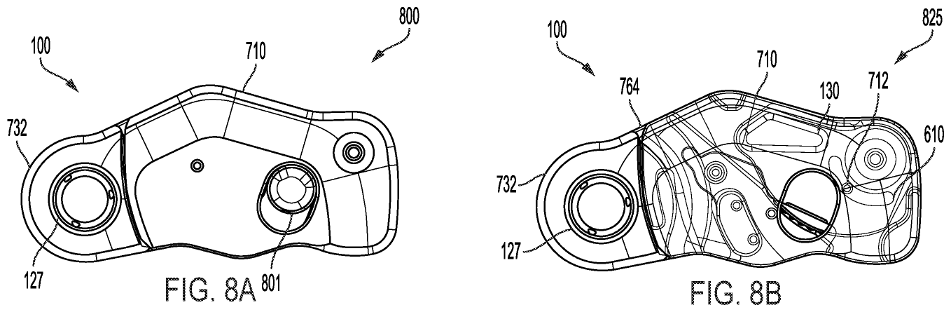

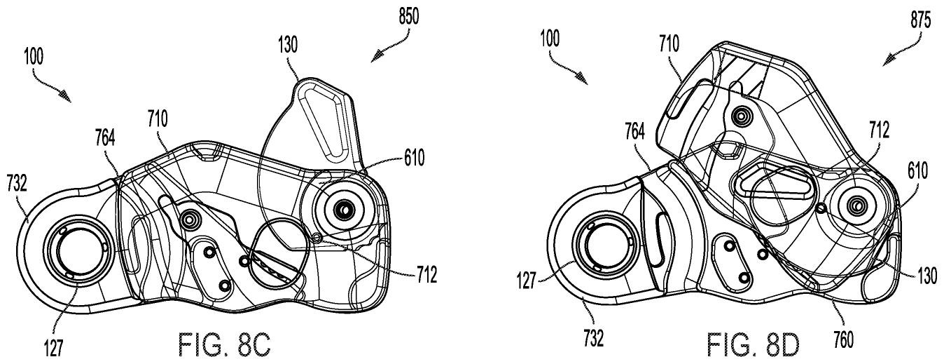

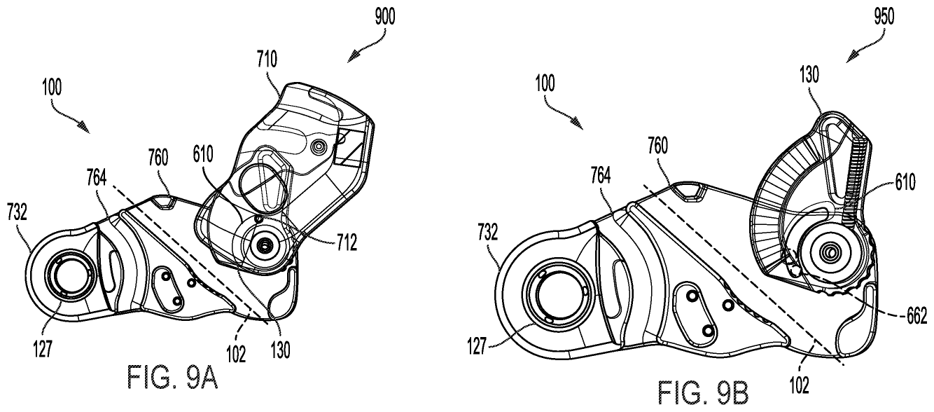

The following description relates to a line grab device, as illustrated in FIG. 1. An interior of a cam of the line grab device is illustrated in FIG. 2. The cam may comprise a groove configured to pinch the line, as illustrated in FIGS. 3A and 3B. FIGS. 4A through 4E illustrate various camming angles at different rotational positions of the cam. FIG. 5 illustrates an alternative shape of a cam of the line grab device. FIG. 6A illustrates a first side of the cam. FIG. 6B illustrates a second side of the cam. FIG. 7A illustrates a side plate of the line grab device. FIG. 7B illustrates a chassis of the line grab device. FIGS. 8A-8D illustrate operation of the line grab device with line being loaded into a pulley zone. FIGS. 9A and 9B illustrates operation of line being loaded into or unloaded from the cam.

In one embodiment of the present disclosure, a device configured to grab a line and slip at a pre-determined load. The device may prevent overloading of a line system and decrease a likelihood of degradation to the line due to excess tension. The device may slip more predictably than rope knots used as a line-grabbing device or the levered and unlevered examples described above. Additionally, set up of the device may be faster, more reliable, and more efficient than the rope knot.

The device, in one example, is a load limiting line grab configured to slip at or above the threshold load. The device includes a spring, an unlevered cam, and a tail. The cam may comprise a groove including a V-shape. The groove may increase friction applied to the line and force the cam to rotate with increased load. In response to the upper threshold load being met or exceeded, the tail may contact the line blocking further rotation of the cam. This may stop the cam from applying more friction to the line, which may prevent degradation to a host line or overload of a line system. The load overcomes the friction of the camming device and initiates a slip event. Once the load decreases below the threshold load, the friction of the camming device is sufficient to hold the load and re-grabs the line. The slipping and grabbing may occur automatically without a user input. As such, the slip does not cause a complete release of load but an upper limit of the load applied to the line.

Herein, terms cam angle and camming angle are used. A cam angle is defined as an angle of rotation of the cam and the camming angle is defined as the angle between a net or an average contact point of the cam (e.g., a centroid of pressure distribution) and a line normal to the line that passes through a center of rotation of the cam.

Embodiments of the line grab device disclosed herein are illustrated and described with a V-shaped groove cam device. In some embodiments, the line grab device may be operated with a uniform spacing groove cam device, such as a linear shaped groove, without departing from the scope of the present disclosure.

FIGS. 1-9B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Turning now to FIG. 1, it shows a device 100. In one example, the device 100 is a line grab device. In some examples, additionally or alternatively, the device 100 may be a standalone line grab, a progress capture pulley, an ascender, a working position device, or a back-up device. An axis system 190 is shown comprising three axes, namely an x-axis parallel to a vertical direction, a y-axis parallel to a horizontal direction, and a z-axis parallel to a transverse direction, normal to the x- and y-axes. It will be appreciated that the device 100 may interact with a line 104 along any of the axes of the axis system 190.

A line path 102 may be configured to receive the line 104. In one example, the line 104 is a rope. The line path 102 may be defined by a cam 130 and a baseplate 110. The line 104 may be selected from a plurality of lines including a variety of lengths, thicknesses (e.g., diameters), and constructions. For example, the line 104 may include one or more of a braided construction, a twisted construction, a liner or a mantle surrounding a core construction, a static construction, a dynamic/flexible construction, a synthetic material, such as nylon or polyester, and a natural material. In this way, the device 100 may be used with a variety of lines.

The baseplate 110 may include a first surface 112, a second surface 122, and a third surface 124. The first surface 112 may transition to the second surface 122 via a first contoured edge 116. The second surface 122 may transition to the third surface 124 via a second contoured edge 117. The third surface 124 may transition to the first surface 112 via a third contoured edge 118. Each of the contoured edges may be curved with no normal angles, thereby smoothing the corners which may prevent the baseplate 110 from catching onto the line 104 or an article of clothing of a user.

The first surface 112 and the second surface 122 may be substantially planar. The third surface 124 may comprise a curved shape. In one example, the third surface 124 may curve toward the first surface 112 and away from an eyelet 126. In one example, the eyelet 126 may be configured to be part of a pulley including a sheave 127 supported by a bearing. By doing this, a user may utilize a mechanical advantage system. receive a second line, a carabiner, or other similar device. The eyelet 126 may be shaped via the sheave 127 configured to rotate based on a movement of the user with respect to the device extending through the eyelet 126. By doing this, an orientation of the device 100 may be maintained as an orientation of the user may change during a descent or an ascent.

The first surface 112 may deviate from planar adjacent to the third contoured edge 118. In one example, the first surface 112 curves away from the line path 102. Thus, the third contoured edge 118 may extend in a direction away from the line path 102 and toward the sheave 127.

The baseplate 110 may further include a first recess 114 adjacent to the cam 130. The first recess 114 may curve toward the second contoured edge 117, away from the cam 130. In one example, the first recess 114 may include a conformal shape relative to the cam 130. The first recess 114 may increase a contact area in which the line 104 is contacted by the device 100 while introducing an angular deviation of the line path 102. Additionally, shaping the first recess 114 conformal or near conformal may increase the contact area to an entire shape of the first recess 114, which may decrease stress concentrations on the line 104.

The first recess 114 may include a plurality of teeth 115. The plurality of teeth 115 may be identical to one another in size and shape. In one example, the plurality of teeth 115 extend in a direction normal to the line path 102.

The cam 130 may include a tail 132 and a protrusion 134 extending from a body 136. The body 136 may include an axle 138 extending through an opening of a bearing 140 thereof, wherein the axle 138 may retain the cam 130 to the device 100 while the bearing 140 may allow the cam 130 to rotate in response to a load applied to the line 104.

The protrusion 134 may comprise a logarithmic shape. That is to say, the camming angle of the cam 130 may be relatively constant when only the protrusion 134 is in contact with the line 104. The cam 130 may deviate from logarithmic at the tail 132, wherein the camming angle may increase due to each of the protrusion 134 and the tail 132 contacting the line 104. This may allow the cam 130 to limit the load applied to the line 104, relative to cams following a logarithmic shape.

A second recess 111 may be along the first surface 112 between the first recess 114 and the third contoured edge 118. In one example, the positioning of the second recess 111 may correspond to a location at which a non-logarithmic portion of the cam 130 may contact the line 104 and press the line 104 against the first surface 112. In one example, the tail 132, which is a non-logarithmic portion of the cam 130 of the example of FIG. 1, may push the line into the second recess 111 and deflect the line before a camming angle effect of the cam grip causes the device 100 to slip. This may create a higher cam rotation and slip force compared to a planar baseplate or a baseplate with only a single recess. If a back-tension is relatively high, then tensile forces in the line may resist deflection into the second recess 111, thereby reducing an effect on slip force compared to a planar baseplate.

A size and a shape of the second recess 111 may be adjusted to enhance the operating conditions of the device 100. A magnitude of an effect of the second recess may be increased by increasing a depth of the recess. Additionally or alternatively, a sensitivity to different level of line tension on a side of the device not tensioned may be adjusted by adjusting a length of the recess along the direction of line path. In one example, increasing the length of the recess may decrease its sensitivity and decreasing the length of the recess may increase its sensitivity. Herein, sensitivity may refer to the magnitude of the effect as a function of the amount of line tension of a side of the device not tension by the device. For example, a shorter recess may allow the line to enter only when a lower tension is present. A longer recess may allow the line to enter the recess when higher amounts of tension are present relative to the shorter recess. Additionally or alternatively, the second recess 111 may include a shape similar to the first recess 114, wherein the second recess 111 may include a V-shaped groove arranged therein. The second recess 111 may further include, additionally or alternatively, a texturing, such as a plurality of teeth, ribbings, or other non-linear features.

The tail 132 may extend in a direction away from the line path 102 in the position of the cam 130 illustrated in the example of FIG. 1. In one example, the tail 132 is raised relative to other examples of cams. The tail 132 may be configured to initiate slip during some loads imparted on the line 104 by blocking the cam 130 from further rotating. More specifically, the tail 132 is configured to contact the line 104 at relatively high loads. In one example, the tail 132 may contact the line at a first threshold load. The first threshold load may be a non-zero, positive value. Once the load increases above a second threshold load, the cam 130 in combination with the tail 132 may no longer grab the line 104 and the line 104 may slip. If the load decreases below the second threshold load, then the cam 130 may re-grab the line 104. Rotation of the cam 130 based on the load is described in greater detail with respect to FIGS. 4A to 4E. In one example, the second threshold load is a non-zero, positive value. The second threshold load may be greater than the first threshold load. The second threshold load may correspond to a load of the line 104 where friction generated between the cam 130 and the line 104 is insufficient to grab the line 104. Additionally or alternatively, the cam 130 may be configured to slip the line 104 at the second threshold load to mitigate degradation to an outer surface of the line 104. In one example, the slipping of the cam 130 is based on one or more of load, aperture (e.g., opening of the line path 102), and friction.

Said another way, the tail 132 blocks rotation of the cam 130 beyond a threshold position, initiating slip due to the friction applied by the cam 130 being less than the load of the line 104. In this way, the rotation of the cam 130 is limited via the line rather than the device 100 or a component thereof. The device 100 may operate on a variety of lines 104 with different diameters or stiffnesses. The slip forces of the device 100 are therefore more accurate, and the device 100 is more versatile.

Herein, grab refers to the line 104 being lockingly engaged with the device 100 such that the device 100 may not travel in a direction parallel to the line. Slip may refer to the line 104 being released by the device 100 such that the device 100 may travel in the direction parallel to the line 104.

In some examples, the cam 130 may be configured with a spiral shape, as shown in FIG. 5. As the cam rotates, portions of the spiral with a greater radius may contact the line. In one example, the radius of the spiral cam may increase at a rate greater than logarithmic, thereby causing a gradual increase in a camming angle with an increase in cam rotation. For example, section 502 of the embodiment 500 of a device, which may be used similarly to the device 100 of FIG. 1, may include a logarithmic shape. Dashed line 504 illustrates a continuation of the logarithmic shape. However, the spiral shaped cam of the embodiment 500 includes a shape with an increasing camming angle due to an increasing radius section 506 beyond the section 502. In this way, the increasing radius section 506 of the spiral-shaped cam of FIG. 5 may correspond to a non-logarithmic section of the cam. That is to say, the cam angle of the device 100 of FIG. 1 and the device of embodiment 500 may comprise a relatively constant camming angle until the tail 132 or the increased radius section 506 contacts the line 104, wherein the camming angle may increase in a stepped manner. The cam may be alternatively configured to include a spiral shape with a radius from a pivot point of the cam (e.g., bearing 140) increasing in a direction of increasing rotation of the cam 130. As portions of the spiral cam with larger radii contact the line, the camming angle increases, such that the camming angle of the spiral shaped cam may gradually increase throughout a rotation of the cam.

The cam 130 further comprises an outer surface 142. In the example of FIG. 1, the outer surface 142 covers interior components of the cam 130 while further obscuring a portion of the line 104. Turning to FIG. 2, it shows an embodiment 200 of the device 100 with the outer surface 142 of the cam 130 hidden. As such, components previously introduced are similarly numbered in this and subsequent figures. An inner body 144, a spring 146, and a groove 148 of the cam 130 are exposed in the example of FIG. 2.

The inner body 144 may comprise a shape similar to the shape of the outer surface 142. In one example, the inner body 144 and the outer surface 142 comprise an apostrophe shape. The apostrophe shape may include a circular portion from which a tail or other element extends, disrupting a shape of the circle. Additionally or alternatively, the inner body 144 and the outer surface 142 may include a spiral shape as described above, or they may include an elliptical shape.

The groove 148 may be cut into a shape of the cam 130 and arranged between the outer surface 142 and the inner body 144. The groove 148 may include a plurality of teeth 150 configured to increase friction against the line 104, thereby allowing the cam 130 to grab the line 104 in response to loads below the second threshold line load. The groove 148 and the plurality of teeth 150 are described in greater detail with respect to FIG. 3A.

The spring 146 and spring plunger 222 may be arranged within a recess 202 of the inner body 144. The spring 146 may be retained within the recess 202 via a spring fastener 224 that is configured to compress the spring 146. The spring plunger 222 is configured to contact the spring on one side, and a cam axle recess 226 in the cam axle 228. The cam axle recess 226 is accessible through a split in the cam bearing 140. This configuration may force the compressed spring 146 to create an overturning moment about the cam axle 228, forcing the cam 130 to rotate anticlockwise towards contact with the rope 104, as shown by arrow 290. The cam axle recess 226 is configured to allow the cam 130 to rotate clockwise sufficiently to enable a user to load and un-load the rope 104.

The device 100 further comprises a guide 162. The guide 162 may be arranged at a portion of the device 100 opposite to a pin 164. In one example, the pin 164 is a protrusion. Each of the guide 162 and the pin 164 may be configured to block overturning of the line 104. By doing this, the line 104 may not counter-rotate the cam 130.

Turning now to FIG. 3A, it shows a view 300 of the groove 148. As illustrated, the groove 148 is shaped via interior surfaces of the outer surface 142 and inner body 144 of the cam 130. The groove 148 may increase in constriction in a direction away from a line path (e.g., line path 102 of FIGS. 1 and 2).

The groove 148 may include the plurality of teeth 150, which may be substantially identical to one another in size and shape. Additionally or alternatively, teeth of the plurality of teeth 150 may be differently sized and/or shaped from one another without departing from the scope of the present disclosure. Neighboring teeth of the plurality of teeth 150 may be separated via a recess or other indentation. As such, adjacent teeth may not touch one another.

The plurality of teeth 150 may comprise rounded surfaces at which the teeth may contact the line. The rounded surface may reduce stress concentrations on the line and increase its longevity.

In one example, the groove 148 is a V-shape. Additionally or alternatively, in some examples, the groove 148 may include other shapes that narrow in width in a direction away from the line path. The line, such as line 104 of FIGS. 1 and 2, may be squeezed between surfaces of the outer surface 142 and the inner body 144 into narrower portions of the groove 148. In this way, the line 104 may be compressed via contact with each side of the groove 148 in addition to the first surface 112 and/or the second surface 114. That is to say, previous line grabbing devices may include two surfaces within the groove, which may form a larger contact area relative to the contact point formed by the groove 148. The angle of the surface of the groove 148 with respect to the first surface 112 may increase a surface pressure relative to a cam without the groove.

FIG. 3B illustrates the triangular shape of the line 104 being pressed into the groove 148, which may further reduce a stress on an outer cover of the line by more evenly distributing pressure. The groove 148 may provide more contact area with the line which increases pressure while adding friction onto the line, thereby keeping the cam 130 energized. In one example, the line is maintained in a pre-determined location, such as a center of the cam, blocking the line from moving or biasing toward the outer surface 142 of the inner body 144. This may further maintain more balanced loads on the bearing 140.

In one example, the angled faces of the groove 148 may generate increased forces due to a wedging effect of the line. The groove 148 further includes three primary area of pressure onto the line 104, which may decrease cross-sectional distortion and resulting stressing against a sheath of the line 104. The V-shape of the groove 148 is further configured to provide a pre-determined path for the line 104 to travel through the cam 130. This may block the line 104 from migrating side to side during grabbing and slipping events. Side to side migration may result in a pinching of the line and off-centered forces being applied thereto. These off-centered forces may degrade the line while also increasing stresses on the bearing of the cam, thereby reducing a durability of the bearing and/or increasing maintenance costs.

Turning now to FIGS. 4A, 4B, 4C, 4D, and 4E, they show various positions of the cam 130 relative to the line 104. FIG. 4A illustrates a first position 400 with a first camming angle 402. In one example, the first position 400 is a starting position of the cam 130 and the first camming angle 402 is between 5 and 25 degrees. Additionally or alternatively, the first camming angle 402 may be between 15 and 25 degrees. In one example, the first camming angle 402 may be equal to about 20 degrees.

FIG. 4B illustrates a second position 410 with a second camming angle 412. The second position 410 may correspond to a more rotated position of the cam 130 relative to the first position 400 of FIG. 4A. However, in one example, due to the logarithmic shape of the protrusion 134 of the cam 130, the second camming angle 412 may be identical to the first camming angle 402.

FIG. 4C illustrates a third position 420 with a third camming angle 422. The third position 420 may correspond to a more rotated position of the cam 130 relative to the second position 410 of FIG. 4B. However, in one example, due to the logarithmic shape of the protrusion 134 of the cam 130, the third camming angle 422 may be identical to the second camming angle 412 and the first camming angle 402. In one example, the angle of the reaction force between the line 104 and cam remains constant, allowing the device to continually gab the line as the load increases and the rope may deform under pressure. The third camming angle 422, along with the first camming angle 402 and the second camming angle 412 of FIGS. 4A and 4B, may be measured based on a line extending from a center of a pivot point of the cam 130 to a contact point and to a surface normal to the line 104. Said another way, the camming angle is measured as the angle between two lines, a first line connecting the contact point of the cam on the line 104 to the center of the cam's pivot point, and a second line that runs from the cam's pivot point and crosses the line 104 at an orthogonal angle. The camming angle determines the relationship between the frictional force of the line on the cam and a pressure exerted by the cam on the line.

Through each positon of the cam 130 shown in FIGS. 4A, 4B, and 4C, the tail 132 is spaced away from the line 104. Only the protrusion 134 may contact the line 104 at each of the first camming angle 402, the second camming angle 412, and the third camming angle 422. However, as the cam 130 moves from the first camming angle 402 to the second camming angle 412, the tail 132 moves closer to the line 104.

FIG. 4D illustrates a fourth position 430 with a fourth camming angle 432. The fourth cam position 430 may correspond to a more rotated position of the cam 130 relative to the third position 420 of FIG. 4C. The fourth camming angle 432 may correspond to a camming angle between a first contact point 434 and a second contact point 436. That is to say, the fourth camming angle 432 may correspond to a net or average contact point between the first and second contact points 434, 436. The first contact point 434 may correspond to a camming angle similar to a camming angle of the first through third positions, where the protrusion 134 contacts the line 104 at the first contact point 434. The second contact point 436 may include a larger camming angle, between 35 to 55 degrees, relative to the camming angle corresponding to the first contact point 436. Thus, the fourth camming angle 432, which is based on an average of the first and second contact points 434, 436, may be between 20 and 50 degrees. In one example, the fourth cam position 430 corresponds to a first threshold position of the cam 130 at which the tail 132 may contact the line 104. While not illustrated in the example of FIG. 4D, the point at which the tail 132 contacts the line (e.g., the second contact point 436), may further comprise pressing the line into the second recess (e.g., second recess 111 of FIG. 1).

Thus, as the cam 130 rotates further through the positions from the first position 400 to the fourth position 430, the cam 130 contacts a greater length of the line 104. By doing this, line tension may increase and inadvertent slip may be avoided.

FIG. 4E illustrates a fifth position 440 with a fifth camming angle 442. The fifth position 440 may correspond to a more rotated position of the cam 130 relative to the fourth position 430 of FIG. 4D. In one example, the fifth position 440 corresponds to a most rotated position of the cam 130. The fifth camming angle 442 may be between 50 and 60 degrees. In one example, the fifth position 440 illustrates a change of the camming angle at a high degree of cam rotation. The camming angle shown is above a threshold angle so that the cam is unlikely or unable to grab the line. Thus, this amount of cam rotation may occur during fewer conditions than the camming angles of FIGS. 4A to 4D. The spring (e.g., spring 146 of FIG. 2) may urge the cam 130 in the direction of the line 104 such that once the line tension decreases the cam 130 may then re-grab the line. In one example, the fifth position 440 may correspond to a second threshold position in which the tail 132 blocks further rotation of the cam 130. In the fifth position 440, the tail 132 may be positioned to re-grab the line 104 quickly such that an amount of slip may be more controlled by a user compared to a line grab device comprising a cam without the protrusion and the tail.

Turning now to FIG. 6A, it shows a first side 600 of the cam 130. The cam 130 includes a first slot 610. The first slot 610 may include an arc shape. In one example, the first slot 610 may curve and match a curvature of a circle. The first slot 610 may be adjacent to an opening 612, wherein the opening 612 may receive a bearing, such as bearing 140 of FIG. 1.

Turning now to FIG. 6B, it shows a second side 650 of the cam 130. The cam 130 includes a second slot 660. The second slot 660 may be shaped identically to the first slot 610. The second slot 660 is curved and matches a curvature of a circle, such as opening 612. The second slot 660 may be identical to the first slot 610 in size. A position of the second slot 660 on the second side 650 may be directly opposite a position of the first slot 610 on the first side 600 along an axis (e.g., the z-axis). That is to say, the distance and spacing of the second slot 660 relative to the opening 612 and other features of the cam 130 on the second side 650 may be identical to the distance and spacing of the first slot 610 relative to the opening 612 and other features of the cam 130 on the first side 600. In some examples, the slots may be positioned at different locations than those illustrated in FIGS. 6A and 6B.

Turning now to FIG. 7A, it shows an embodiment 700 of a side plate 710 of a line grab device, such as the device 100 of FIG. 1. The side plate 710 may include a side plate protrusion 712 that interacts with the first slot 610 of the cam 130 shown in FIG. 6A. The side plate protrusion 712 may slide to and between extreme ends of the first slot 610 as the side plate 710 and/or the cam 130 is/are actuated through different positions. The side plate 710 may cover one or more line paths of the line grab device. For example, the side plate 710 is configured to cover or expose each of a pulley line slot and a line path (e.g., line path 102 of FIG. 1) of the cam 130 based on a position of the side plate 710. In one example, the side plate 710 is moveable to a closed position, a first open position, or a second open position.

The side plate protrusion 712 may be arranged between a first side plate opening 722 and a side plate feature 724. The first side plate opening 722 may receive an end of a fastener, such as the axle 138 of FIG. 1, for retaining the cam 130, as shown in FIG. 1. The side plate 710 may be rotatably coupled to and/or integrated with (e.g., the side plate 710 and the axle 138 are a single-piece) a second extreme end of the axle 138, wherein a chassis (e.g., chassis 760 of FIG. 7B) is fixedly coupled to a first extreme end of the axle 138, opposite the second extreme end. The cam 130 may be rotatably coupled to a portion of the axle 138 between the first extreme end and the second extreme end. The side plate feature 724 may be shaped to accommodate a chassis feature (e.g., base plate 110 of FIG. 7B). The side plate feature 724 may be positioned between the side plate protrusion 712 and the sheave 127.

In one example, the side plate 710 may be spaced away from the sheave 127, wherein the device may include a sheave cover 732. The sheave cover 732 may be arranged at pulley portion of the device. The sheave cover 732 may include a curvature directed toward the side plate 710, wherein the curvature may retain line adjacent to the sheave 127. The sheave cover 732 may be a separate piece from the side plate 710. Thus, the sheave cover 732 may be stationary when the side plate 710 is actuated. In one example, the side plate 710 interlocks with the sheave cover 732.

Turning now to FIG. 7B, it shows an embodiment 750 of the chassis 760 of a line grab device, such as the device 100 of FIG. 1. The chassis 760, in combination with the side plate 710 of FIG. 7A, may form outer surfaces of the line grab device that cover the cam 130 and line paths of the device. Together, the chassis 760 and the side plate 710 may retain the cam 130 along with line and other features of the line grab device.

The chassis 760 may include a chassis protrusion 762. The chassis protrusion 762 may interface with the second slot 660 on the second side 650 of the cam 130, as shown in FIG. 6B. The chassis protrusion 762 may slide to and between extreme ends of the second slot 660. In one example, the chassis protrusion 762 may be a similar size and shape to the side plate protrusion 712 of FIG. 7A. Each of the chassis protrusion 762 and the side plate protrusion 712 may include a cylindrical shape. During some operating conditions, the positions of the chassis protrusion 762 and the side plate protrusion 712 may be identical. During other operating conditions, such as when the side plate 710 is actuated, the positions of the chassis protrusion 762 and the side plate protrusion 712 may be different.

A pulley line slot 764 may be arranged between the sheave 127 and the baseplate 110. Line may be inserted and passed through the pulley line slot 764 in one of the positions of the side plate 710. The side plate 710 and the sheave cover 732 may retain the line in the pulley line slot 764 and block debris from contacting the line, thereby increasing a longevity thereof.

The chassis protrusion 762 and the side plate protrusion 712 may move independently of the cam 130 or vice versa. Operation of the side plate protrusion 712 for loading or unloading only a pulley line slot 764 or for loading or unloading a line grab portion of the device (e.g., the cam 130) is described in greater detail below. Turning now to FIGS. 8A, 8B, 8C, and 8D, they show embodiments of the device 100. FIG. 8A shows an embodiment 800 of the device 100 with the side plate 710 in a closed position. FIG. 8B shows an embodiment 825 of the device 100 with the side plate 710 rendered transparent and in the closed position and cam 130 in a closed position. FIG. 8B shows portions of the device 100 covered and/or blocked by the side plate 710 when in the closed position. FIG. 8C shows an embodiment 850 of the device 100 with the side plate 710 in the closed position and the cam 130 actuated from the closed position to an open position. FIG. 8D shows an embodiment 875 of the device 100 with the side plate 710 in a first open position and the cam 130 in a closed position. FIGS. 8A-8D are described in tandem herein.

When the side plate 710 is in the closed position, the side plate 710 may overlap with a portion of the sheave cover 732. In one example, the side plate 710 may overlap with the curved portion of the sheave cover 732. The side plate 710 may be exterior to the to the sheave cover 732 and cover the line when the line is arranged in the pulley line slot 764.

When each of the cam 130 and the side plate 710 are in respective closed positions, the side plate protrusion 712 is positioned between extreme ends of the first slot 610. The chassis protrusion 762 may also be positioned between extreme ends of the first slot 610, in a position identical to the side plate protrusion 712.

In the embodiment 850, the cam 130 is actuated independently of the side plate 710 from the closed position to the open position. The side plate 710 may remain stationary as the cam 130 is actuated from the closed position to the open position. When the cam 130 is in the open position and the side plate 710 is in the closed position, line may slip through the line path without being unloaded from the line path. That is to say, the line may slip without being removed from the device 100. When the cam 130 is in the open position and the side plate 710 is in the closed position, the side plate protrusion 712 and the chassis protrusion 762 may be pressed against a first extreme end of the first slot 610 and the second slot 660, respectively. The protrusions may block further articulation of the cam 130 beyond the open position.

In the embodiment 875, the side plate 710 is actuated independently of the cam 130. In one example, the cam 130 is maintained in the closed position and the side plate 710 is actuated from the closed position to the first open position. In the first open position, the pulley line slot 764 is exposed and line may be loaded or unloaded from the pulley line slot 764. The first open position may include where the side plate 710 is actuated a first predetermined distance from the closed position that exposes the pulley line slot 764 and occludes the cam 130 and the line path (e.g., line path 102) thereof. Thus, in the first open position, line may not be unloaded or loaded into the line grab portion of the device 100, while line may be loaded/unloaded into the pulley portion of the device 100.

When the side plate 710 is in the first open position, the side plate protrusion 712 may be pressed against the second extreme end of the first slot 610. The chassis protrusion 762 may be between the first extreme end and the second extreme end of the second slot 660. In one example, the chassis protrusion 762 may only be actuated from the position between the first extreme end and the second extreme end, similar to the position of the side plate protrusion 712 in FIG. 8B, to a position pressed against the first extreme end of the second slot 660 for all positions of the cam 130 and the side plate 710.

In one example, the side plate 710 may be actuated once a latch 801 is actuated. The latch 801 may retain the side plate 710 in the closed position, in relation to the chassis 760 of FIG. 7B, when in a latched position. When the latch 801 is actuated to an unlatched position, the side plate 710 may be actuated to the first open position or the second open position, shown in FIG. 9A. In one example, resistance from the cam 130 may provide feedback to a user that the side plate 710 has been actuated to the first open position, wherein actuating the side plate 710 to the second open position includes actuating the cam 130 with the side plate 710. The latch 801 may lock the travel restriction features of the device 100 to block movement of the side plate 710 when in the latched position. In one example, a recess or other feature may be the travel restriction feature with which the latch 801 engages.

Turning now to FIGS. 9A and 9B, they show embodiments 900 and 950, respectively, of the side plate 710 in a second open position and the cam 130 in the open position. The second open position may be further from the closed position of the side plate 710 than the first open position. In one example, when the side plate 710 is actuated from the closed position to the second open position, the side plate 710 moves through the first open position during its actuation to the second open position.

In one embodiment, the side plate protrusion 712 is pressed against the second extreme of the first slot 610 when the side plate 710 is in the second open position and the cam 130 is in the open position. The chassis protrusion 662 is pressed against the first extreme end of the second slot 660 when the cam 130 is in the open position.

In the second open position of the side plate 710 and the open position of the cam 130, line may be loaded or unloaded from the line path 102 of the grab portion of the device. Additionally or alternatively, line may be loaded or unloaded from the pulley line slot 764.

An example operation of the line grab device including the side plate, the chassis, and the cam may include a user using a single hand to unlatch the side plate and actuate the side plate from the closed position to the second open position. The cam may be actuated from the closed position to the open position as the side plate is operated via the single hand of the user. The side plate may be held in the second open position and line may be loaded into a line path of the line grab device. The cam may be actuated to its closed position, which may also move the side plate to its first open position by the single hand of the user. As such, the line may be retained in the line path of the cam and the user may now load line into the pulley line slot with the single hand without worrying about the line being released from the line path of the cam. Once the pulley line slot is loaded with line, the single hand of the user may actuate the side plate to the closed position and retain the side plate in the closed position via the latch. The user may then operate device and adjust the camming angle of the cam to adjust a line slip when being suspended and/or descending via the line grab device and line.

In one example, the device includes a retaining system with a plurality of travel restriction features that interlock with one another to permit or block movement of one or more components of the device. The retaining system may include grooves, recesses, pins, protrusions, and the like, that limit actuation to a determined range. A latch may block all features of the retaining system when in a latched position such that the components of the device are stationary. When the latch is unlatched, the components of the device may move via one or more of the travel restriction features moving and/or separating from a complementary component.

An embodiment of a device configured to couple to a line includes a cam shaped to increase a camming angle as rotation of the cam increases relative to a starting position, wherein the camming angle is from a center of a pivot point of the cam to a net contact point between the cam and the line and an axis orthogonal to the line. A first example of the device further includes where the cam comprises a tail configured to contact the line in response to the cam rotating beyond a first threshold position. A second example of the device, optionally including the first example, further includes where the tail blocks rotation of the cam beyond a second threshold position. A third example of the device, optionally including one or more of the previous examples, further includes where the cam comprises a groove, and wherein a shape of the groove increases in width in a direction away from a pivot point of the cam. A fourth example of the device, optionally including one or more of the previous examples, further includes where the groove comprises a plurality of teeth configured to contact the rope. A fifth example of the device, optionally including one or more of the previous examples, further includes where the cam and a baseplate interact with a rope, wherein the baseplate comprises a recess configured to support the line. A sixth example of the device, optionally including one or more of the previous examples, further includes where the cam includes a spring configured to initiate a turning motion of the cam, and wherein the cam further includes a tail configured to initiate slipping of the cam and block rotation of the cam beyond a threshold rotation.

An embodiment of a line grabbing device includes a cam with a V-shaped groove increasing in width away from a bearing of the cam, a spring configured to overturn the cam towards contact with a line extending through the V-shaped groove, and a non-logarithmic portion of the cam configured to block rotation of the cam beyond a threshold rotation. A first example of the line grabbing device further includes where the non-logarithmic portion is a tail, wherein the tail contacts a line at the threshold rotation and increases a camming angle of the cam. A second example of the line grabbing device, optionally including the first example, further includes where a load of the line decreases beyond the threshold rotation, and wherein the line slips. A third example of the line grabbing device, optionally including one or more of the previous examples, further includes where the cam grabs the line in response to the line load being less than a threshold load. A fourth example of the line grabbing device, optionally including one or more of the previous examples, further includes where the line grabbing device grabs and slips line without a user input. A fifth example of the line grabbing device, optionally including one or more of the previous examples, further includes where the cam is unlevered. A sixth example of the line grabbing device, optionally including one or more of the previous examples, further includes where the cam and a baseplate grab a line at a contact area, and wherein the baseplate comprises a recess at the contact area. A seventh example of the line grabbing device, optionally including one or more of the previous examples, further includes where wherein the non-logarithmic portion corresponds to an increased radius of a spiral shape of the cam.

The disclosure provides support for a device configured to couple to a line including a cam arranged between a side plate and a chassis and a retaining system including at least one protrusion positioned to slide within at least one slot. A first example of the device further includes where the cam and the side plate are moveable independently of one another. A second example of the device, optionally including the first example, further includes a latch configured to retain the side plate in a closed position. A third example of the device, optionally including one or more of the previous examples, further includes where the side plate is actuated to a first open position when the latch is unlatched and the cam is maintained in a closed position. A fourth example of the device, optionally including one or more of the previous examples, further includes where the cam is actuated to an open position when the latch is unlatched and the side plate is actuated to a second open position. A fifth example of the device, optionally including one or more of the previous examples, further includes where the first open position exposes a pulley line slot and obscures a line path of the device. A sixth example of the device, optionally including one or more of the previous examples, further includes where the side plate interlocks with a portion of a sheave cover.

The disclosure provides additional support for a line grab device including a chassis comprising a line grab portion and a pulley portion, wherein a sheave is arranged in the pulley portion and a cam is arranged in the line grab portion and a side plate rotatably coupled to an end of an axle of the cam, wherein the side plate is configured to actuate between a closed position, a first open position, and a second open position, wherein the cam comprises a first slot interfaced with a side plate protrusion and a second slot interfaced with a chassis protrusion. A first example of the line grab device further includes where the chassis is fixedly coupled or integrated with the axle. A second example of the line grab device, optionally including the first example, further includes where the side plate protrusion and the chassis protrusion are arranged between a first extreme end and a second extreme end of the first slot and the second slot when the cam is in a closed position. A third example of the line grab device, optionally including one or more of the previous examples, further includes where the side plate protrusion and the chassis protrusion are pressed against the first extreme end when the cam is in an open position and the side plate is in the closed position. A fourth example of the line grab device, optionally including one or more of the previous examples, further includes where the side plate protrusion is pressed against the second extreme end of the first slot and the chassis protrusion is between the first extreme end and the second extreme end when the cam is in a closed position and the side plate is in the first open position. A fifth example of the line grab device, optionally including one or more of the previous examples, further includes where the side plate protrusion is pressed against the second extreme end of the first slot and the chassis protrusion is pressed against the first extreme end when the cam is in an open position and the side plate is in the second open position. A sixth example of the line grab device, optionally including one or more of the previous examples, further includes where the closed position of the side plate covers a pulley line slot and a line path defined by the cam. A seventh example of the line grab device, optionally including one or more of the previous examples, further includes where the first open position of the side plate exposes the pulley line slot and covers the line path. An eighth example of the line grab device, optionally including one or more of the previous examples, further includes where the second open position of the side plate exposes the pulley line slot and the line path.

The disclosure provides further support for a line grab device including a cam rotatably coupled to an axle, a chassis fixedly coupled to the axle, and a side plate rotatably coupled to the axle, wherein the side plate is configured to cover or expose each of a pulley line slot and a line path of the cam based on a position of the side plate, wherein the side plate is moveable to a closed position, a first open position, or a second open position, wherein the cam comprises a first slot interfaced with a side plate protrusion of the side plate and a second slot interfaced with a chassis protrusion of the chassis. A first example of the line grab device further includes where the side plate protrusion and the chassis protrusion comprise a cylindrical shape, and wherein the first slot and the second slot comprise an arc shape. A second example of the line grab device, optionally including the first example, further includes where the cam and the side plate are rotatable independent of one another. A third example of the line grab device, optionally including one or more of the previous examples, further includes where a latch retains the side plate in the closed position.

An embodiment of a system for a line grabbing device including a line extending through an opening arranged between a groove of a cam and a recess of a baseplate, wherein the groove of the cam decreases in width in a direction away from the line. A first example of the system further includes where the groove comprises a V-shape, and wherein the line is configured to compress into a triangular shape as it extends through the groove. A second example of the system, optionally including the first example, further includes where the cam is unlevered, and wherein a tail of the cam blocks rotation of the cam greater than a threshold rotation, and wherein the cam is configured to slip the line in response to a line tension greater than a friction applied at a position corresponding to the threshold rotation. A third example of the system, optionally including one or more of the previous examples, further includes where the cam grabs the line in response to the line tension being equal to or less than the friction applied at the position. A fourth example of the system, optionally including one or more of the previous examples, further includes where a user provides no inputs when the cam grabs and slips the line.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A device configured to couple to a line, comprising:
a cam arranged between a side plate and a chassis; and
a retaining system including at least one protrusion positioned to slide within at least one slot.

2. The device of claim 1, wherein the cam and the side plate are moveable independently of one another.

3. The device of claim 1, further comprising a latch configured to retain the side plate in a closed position.

4. The device of claim 3, wherein the side plate is actuated to a first open position when the latch is unlatched and the cam is maintained in a closed position.

5. The device of claim 4, wherein the cam is actuated to an open position when the latch is unlatched and the side plate is actuated to a second open position.

6. The device of claim 4, wherein the first open position exposes a pulley line slot and obscures a line path of the device.

7. The device of claim 1, wherein the side plate interlocks with a portion of a sheave cover.

8. A line grab device, comprising:
a chassis comprising a line grab portion and a pulley portion, wherein a sheave is arranged in the pulley portion and a cam is arranged in the line grab portion; and
a side plate rotatably coupled to an end of an axle of the cam, wherein the side plate is configured to actuate between a closed position, a first open position, and a second open position;
wherein the cam comprises a first slot interfaced with a side plate protrusion and a second slot interfaced with a chassis protrusion.

9. The line grab device of claim 8, wherein the chassis is fixedly coupled or integrated with the axle.

10. The line grab device of claim 8, wherein the side plate protrusion and the chassis protrusion are arranged between a first extreme end and a second extreme end of the first slot and the second slot when the cam is in a closed position.

11. The line grab device of claim 10, wherein the side plate protrusion and the chassis protrusion are pressed against the first extreme end when the cam is in an open position and the side plate is in the closed position.

12. The line grab device of claim 10, wherein the side plate protrusion is pressed against the second extreme end of the first slot and the chassis protrusion is between the first extreme end and the second extreme end when the cam is in a closed position and the side plate is in the first open position.

13. The line grab device of claim 10, wherein the side plate protrusion is pressed against the second extreme end of the first slot and the chassis protrusion is pressed against the first extreme end when the cam is in an open position and the side plate is in the second open position.

14. The line grab device of claim 8, wherein the closed position of the side plate covers a pulley line slot and a line path defined by the cam.

15. The line grab device of claim 14, wherein the first open position of the side plate exposes the pulley line slot and covers the line path.

16. The line grab device of claim 14, wherein the second open position of the side plate exposes the pulley line slot and the line path.

17. A line grab device, comprising:
a cam rotatably coupled to an axle;
a chassis fixedly coupled to the axle; and
a side plate rotatably coupled to the axle, wherein the side plate is configured to cover or expose each of a pulley line slot and a line path of the cam based on a position of the side plate, wherein the side plate is moveable to a closed position, a first open position, or a second open position; wherein
the cam comprises a first slot interfaced with a side plate protrusion of the side plate and a second slot interfaced with a chassis protrusion of the chassis.

18. The line grab device of claim 17, wherein the side plate protrusion and the chassis protrusion comprise a cylindrical shape, and wherein the first slot and the second slot comprise an arc shape.

19. The line grab device of claim 17, wherein the cam and the side plate are rotatable independent of one another.

20. The line grab device of claim 17, further comprising a latch retains the side plate in the closed position.
